(19) United States
(12) Patent Application Publication
(10) Pub. No.: US 2026/0326590 A1
(43) Pub. Date: Oct. 22, 2026

(54) HIGH POWER DENSITY POWER CONVERSION FOR VEHICLES

(71) Applicant: GM GLOBAL TECHNOLOGY OPERATIONS LLC, DETROIT, MI (US)

(72) Inventors: Chandra S. Namuduri, Troy, MI (US); Mohamed Ahmed Kamel Ahmed, Birmingham, MI (US); Rashmi Prasad, Troy, MI (US); Minh-Khai Nguyen, Troy, MI (US)

(21) Appl. No.: 19/185,528

(22) Filed: Apr. 22, 2025

(51) Int. Cl. B60L 53/22; B60L 55/00; B60L 58/20; H02J 7/00; H02J 7/06

(52) U.S. Cl. CPC B60L 53/22; B60L 55/00; B60L 58/20; H02J 7/06; H02J 7/485; H02J 7/64; B60L 2210/30; H02J 2207/20

(57) ABSTRACT

A power converter circuit includes a multi-port power converter to convert alternating current (AC) electrical power from an AC side of the multi-port power converter to a direct current (DC) side of the multi-port power converter. The AC side of the multi-port power converter is electrically connected to an AC source. The power converter circuit further includes an onboard charging module electrically connected to the DC side of the multi-port power converter and to a high voltage battery. The power converter circuit further includes an accessory power module electrically connected to the DC side of the multi-port power converter and to a low voltage battery. The power converter circuit further includes a controller to control a first plurality of switches associated with the AC side of the multi-port power converter and a second plurality of switches associated with the DC side of the multi-port power converter.

The subject disclosure relates to vehicles, and in particular to architectures for high power density power conversion for vehicles.

Modern vehicles (e.g., a car, a motorcycle, a boat, or any other type of automobile) may be equipped with one or more batteries to provide electrical power to various systems of the vehicle. For example, an electric vehicle may include one or more batteries to provide electrical power to one or more electric motors, which provide propulsion to the vehicle. This configuration of vehicle is referred to as a battery electric vehicle (BEV). Other types of vehicles may also be equipped with batteries, such as vehicles with combustion engines, hybrid-electric vehicles, and/or the like, including combinations and/or multiples thereof.

Many modern vehicles, especially hybrids and electric vehicles, use both high-voltage (HV) and low-voltage (LV) battery systems to power different components efficiently. The HV battery, typically ranging from substantially 200V to substantially 800V, is used to drive the electric motor and support energy-intensive functions, such as fast charging and regenerative braking. The LV battery, usually a substantially 12V or substantially 48V battery, powers vehicle electronics, such as lighting, infotainment, and safety features, ensuring reliable operation even when the HV system is inactive.

Vehicles may utilize an onboard charging module (OBCM) to charge a battery (e.g., the HV and/or LV battery) of the vehicle from an external source, such as the power grid. OBCMs manage the conversion of alternating current (AC) power from an external source into direct current (DC) power to charge the vehicle's high-voltage battery. They regulate charging speed, voltage, and current to ensure safe and efficient energy transfer while protecting the battery from overcharging or overheating. OBCMs often include power factor correction and communication interfaces to interact with charging stations and vehicle control systems. Advanced OBCM s support bidirectional charging, enabling vehicle-to-grid (V2G), vehicle-to-vehicle (V2V), vehicle-to-load (V2L), and/or vehicle-to-home (V2H) capabilities for enhanced energy management.

Vehicles may also utilize an accessory power module (APM), which is an electronic control unit used to manage and distribute power to auxiliary systems, such as lighting, entertainment, climate control, and other convenience features. APMs help regulate voltage, ensure efficient power allocation, and protect circuits from overloads or faults. APMs can be found in both conventional and electric vehicles, improving energy efficiency and reducing strain on the main electrical system.

It is desirable to provide architectures for high power density power conversion for vehicles.

### SUMMARY

In one embodiment, a power converter circuit for a vehicle is provided. The power converter circuit includes a multi-port power converter to convert alternating current (AC) electrical power from an AC side of the multi-port power converter to a direct current (DC) side of the multi-port power converter, wherein the AC side of the multi-port power converter is electrically connected to an AC source. The power converter circuit further includes an onboard charging module electrically connected to the DC side of the multi-port power converter and to a high voltage (HV) battery. The power converter circuit further includes an accessory power module electrically connected to the DC side of the multi-port power converter and to a low voltage (LV) battery. The power converter circuit further includes a controller to control a first plurality of switches associated with the AC side of the multi-port power converter and a second plurality of switches associated with the DC side of the multi-port power converter, wherein the controller controls the first plurality of switches and the second plurality of switches based on an operating mode of the vehicle.

In addition to one or more of the features described herein, or as an alternative, further embodiments of the power converter circuit may include that the multi-port power converter is an indirect AC/DC converter.

In addition to one or more of the features described herein, or as an alternative, further embodiments of the power converter circuit may include that the multi-port power converter is a direct AC/DC converter.

In addition to one or more of the features described herein, or as an alternative, further embodiments of the power converter circuit may include that the first plurality of switches and the second plurality of switches are integrated into a single modular package.

In addition to one or more of the features described herein, or as an alternative, further embodiments of the power converter circuit may include that the first plurality of switches are connected in parallel with a voltage overshoot absorption circuit.

In addition to one or more of the features described herein, or as an alternative, further embodiments of the power converter circuit may include that the multi-port power converter includes a plurality of transformer windings, where the plurality of transformer windings are connected to accept or provide different voltages on each winding.

In addition to one or more of the features described herein, or as an alternative, further embodiments of the power converter circuit may include that a high voltage bus of the onboard charging module is pre-charged using the LV battery or the AC source prior to connecting the HV battery to the onboard charging module.

In addition to one or more of the features described herein, or as an alternative, further embodiments of the power converter circuit may include that the multi-port power converter includes a split winding.

In addition to one or more of the features described herein, or as an alternative, further embodiments of the power converter circuit may include that the onboard charging module includes integrated power decoupling.

In addition to one or more of the features described herein, or as an alternative, further embodiments of the power converter circuit may include a DC vehicle-to-load module electrically connected to the DC side of the multi-port power converter and to a low voltage DC load.

In addition to one or more of the features described herein, or as an alternative, further embodiments of the power converter circuit may include an AC vehicle-to-load module electrically connected to the AC side of the multi-port power converter and to an AC load.

In another embodiment, a vehicle is provided. The vehicle includes a high voltage battery to provide electrical power to an electric motor of the vehicle. The vehicle further includes a low voltage battery to provide electrical power to an electrical system of the vehicle. The vehicle further includes a multi-port power converter to convert alternating current (AC) electrical power from an AC side of the multi-port power converter to a direct current (DC) side of the multi-port power converter, wherein the AC side of the multi-port power converter is electrically connected to an AC source. The vehicle further includes an onboard charging module electrically connected to the DC side of the multi-port power converter and to a high voltage (HV) battery. The vehicle further includes an accessory power module electrically connected to the DC side of the multi-port power converter and to a low voltage (LV) battery. The vehicle further includes a controller to control a first plurality of switches associated with the AC side of the multi-port power converter and a second plurality of switches associated with the DC side of the multi-port power converter, wherein the controller controls the first plurality of switches and the second plurality of switches based on an operating mode of the vehicle.

In addition to one or more of the features described herein, or as an alternative, further embodiments of the vehicle may include that the multi-port power converter includes a plurality of transformer windings, where the plurality of transformer windings are connected to provide different voltages on each winding.

In addition to one or more of the features described herein, or as an alternative, further embodiments of the vehicle may include that a high voltage bus of the onboard charging module is pre-charged using the LV battery or the AC source prior to connecting the HV battery to the onboard charging module.

In addition to one or more of the features described herein, or as an alternative, further embodiments of the vehicle may include that the multi-port power converter includes a split winding.

In addition to one or more of the features described herein, or as an alternative, further embodiments of the vehicle may include that the onboard charging module includes integrated power decoupling.

In addition to one or more of the features described herein, or as an alternative, further embodiments of the vehicle may include a DC vehicle-to-load module electrically connected to the DC side of the multi-port power converter and to a DC load.

In addition to one or more of the features described herein, or as an alternative, further embodiments of the vehicle may include an AC vehicle-to-load module electrically connected to the AC side of the multi-port power converter and to an AC load.

In another embodiment a method is provided. The method includes determining an operating mode of a vehicle. The method further includes controlling a first plurality of switches and a second plurality of switches based at least in part on the operating mode of the vehicle, wherein the first plurality of switches and the second plurality of switches are disposed in a power converter circuit. The power converter circuit includes a multi-port power converter to convert alternating current (AC) electrical power from an AC side of the multi-port power converter to a direct current (DC) side of the multi-port power converter, wherein the AC side of the multi-port power converter is electrically connected to an AC source. The power converter circuit further includes an onboard charging module electrically connected to the DC side of the multi-port power converter and to a high voltage (HV) battery. The power converter circuit further includes an accessory power module electrically connected to the DC side of the multi-port power converter and to a low voltage (LV) battery. The power converter circuit further includes a controller to control the first plurality of switches, which are associated with the AC side of the multi-port power converter, and the second plurality of switches, which are associated with the DC side of the multi-port power converter.

In addition to one or more of the features described herein, or as an alternative, further embodiments of the method may include that the multi-port power converter includes a plurality of transformer windings, where the plurality of transformer windings are connected to provide different voltages on each winding.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle supporting architectures for high power density power conversion using a power converter circuit according to one or more embodiments;

FIG. 2A is a block diagram of a power converter circuit according to one or more embodiments;

FIG. 2B is a block diagram of a power converter circuit according to one or more embodiments;

FIG. 2C is a block diagram of a power converter circuit according to one or more embodiments;

FIG. 2D is a block diagram of a power converter circuit according to one or more embodiments;

FIG. 2E is a block diagram of a power converter circuit according to one or more embodiments; and

FIG. 3 a flow diagram of a method for high power density power conversion for vehicles according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (A SIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein provides architectures that provide high power density power conversion for vehicles.

The propulsion systems of existing electric vehicles (EVs), including hybrid electric vehicles (HEVs) and plug-in hybrid electric vehicles (PHEVs), use an onboard charging module to charge a battery of the vehicle from the electrical grid. Such vehicles also use an accessory power module to supply electrical power to various other systems of the vehicle, such as infotainment systems, climate control systems, and/or the like.

In the realm of EVs, the demand for efficient and compact power conversion systems is ever-increasing. As these vehicles become more prevalent, there is a desire for high power density and efficient power conversion systems that can handle multiple functions, such as onboard charging and accessory power management. Existing power conversion systems often require separate modules for each function, leading to increased size, weight, complexity, and cost. These systems typically involve multiple stages of power conversion, which can result in significant energy losses and reduced overall efficiency.

Power conversion systems for EVs and HEVs often involve complex architectures with multiple discrete components, such as separate OBCMs and APMs. These systems can be bulky and inefficient, as they use large filter capacitors and extensive magnetic components to manage power conversion and distribution. Additionally, the integration of these components can be challenging, leading to increased design complexity and potential reliability issues. The need for multiple power conversion stages further exacerbates these disadvantages, as each stage introduces additional losses and reduces the overall system efficiency.

One or more embodiments described herein address these and other shortcomings by providing high power density power conversion for vehicles. According to one or more embodiments, high power density power conversion architectures are provided that integrate an isolated single-stage AC to high voltage DC OBCM with an APM using multi-port planar magnetics. Such embodiments minimize the size of the filter capacitor and magnetic components, thereby achieving high efficiency and high power density simultaneously. One or more embodiments leverages a multi-port power converter that integrates a single-stage indirect or direct AC/DC converter configuration for the OBCM and APM, sharing the high voltage DC side bridge circuit and transformer winding. This integration not only reduces the overall size and weight of the power conversion system but also enhances the vehicle's efficiency by minimizing energy losses associated with multiple conversion stages.

One or more embodiments described herein can be applied to any suitable hybrid vehicle, such as mild hybrids, full hybrids (e.g., parallel hybrids and series hybrids), plug-in hybrids, electric vehicles with range extender hybrids, and/or the like, including combinations and/or multiples thereof.

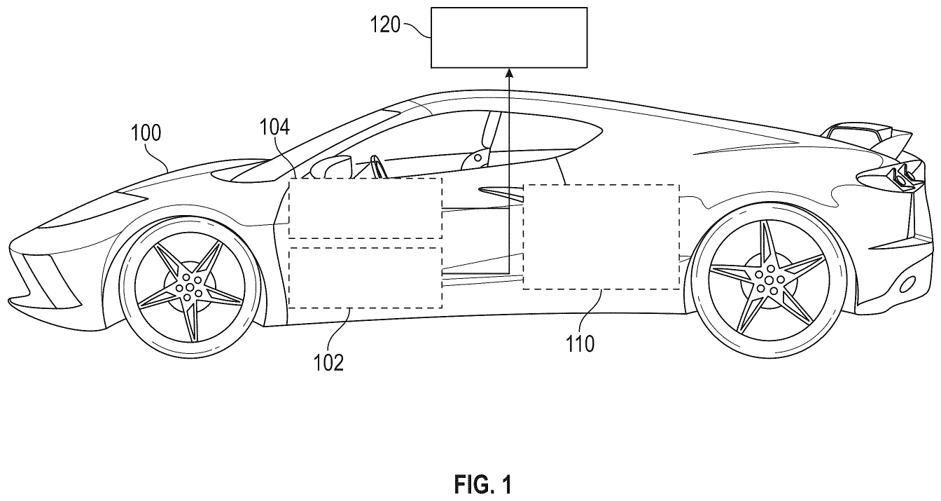

FIG. 1 is an illustration of a vehicle 100 supporting architectures for high power density power conversion using a power converter circuit 110 according to one or more embodiments. The vehicle 100 serves as an example platform for implementing the described architectures for high power density power conversion. The vehicle 100 integrates various components to facilitate these functionalities, including a battery 102 (which may represent one or more of a high voltage (HV) battery, a low voltage (LV) battery, and/or the like, including combinations and/or multiples thereof), an internal combustion engine (ICE) 104, and the power converter circuit 110. The vehicle 100 can be any type of automobile, such as a car, truck, van, bus, motorcycle, or boat. The vehicle 100 may be powered by gasoline, diesel, or a combination of electrical power from the battery 102 and the ICE 104, as seen in HEVs or PHEVS.

The battery 102 represents one or more batteries within the vehicle 100. The battery 102 can be a single battery, multiple batteries, or a battery system. The battery 102 receives electrical power from various sources, including external power source 120 (also referred to as “an AC source”) or an alternator or generator of the vehicle 100. The battery 102 supplies electrical power to an electric motor for vehicle propulsion, internal systems like infotainment or climate control, external systems or devices connected to the vehicle 100 (V2L operations), other vehicles connected to the vehicle 100 (e.g., V2V charging), such as an external vehicle, and/or the like, including combinations and/or multiples thereof.

The ICE 104 is a component of the vehicle 100, providing mechanical power that can be converted into electrical power for various applications. The ICE 104 can be fueled by gasoline, diesel, or other suitable fuels. In the context of V2V and V2L operations, the ICE 104 works in conjunction with other components (e.g., a generator and an inverter) to generate and regulate electrical power, which can be used to charge the battery 102 or supply power to external loads.

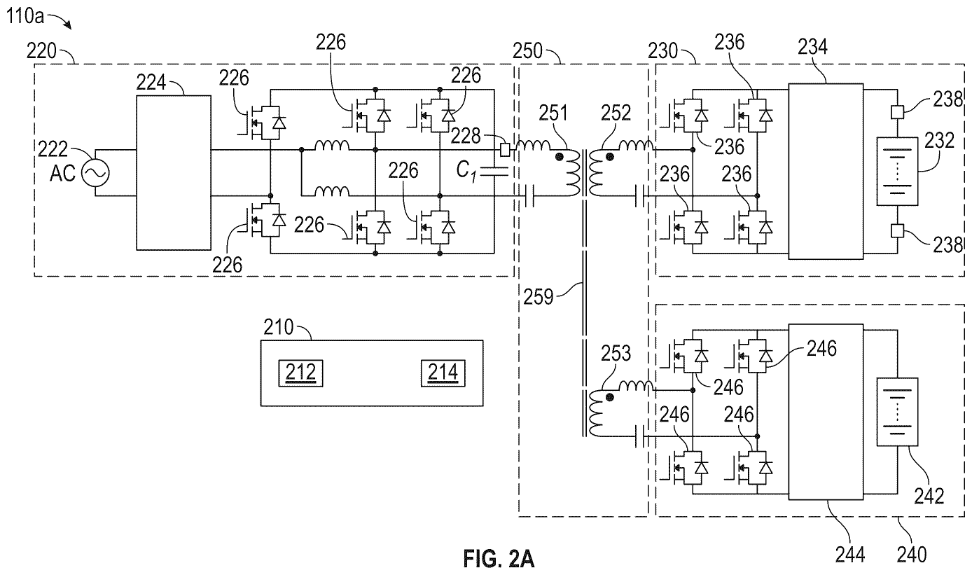

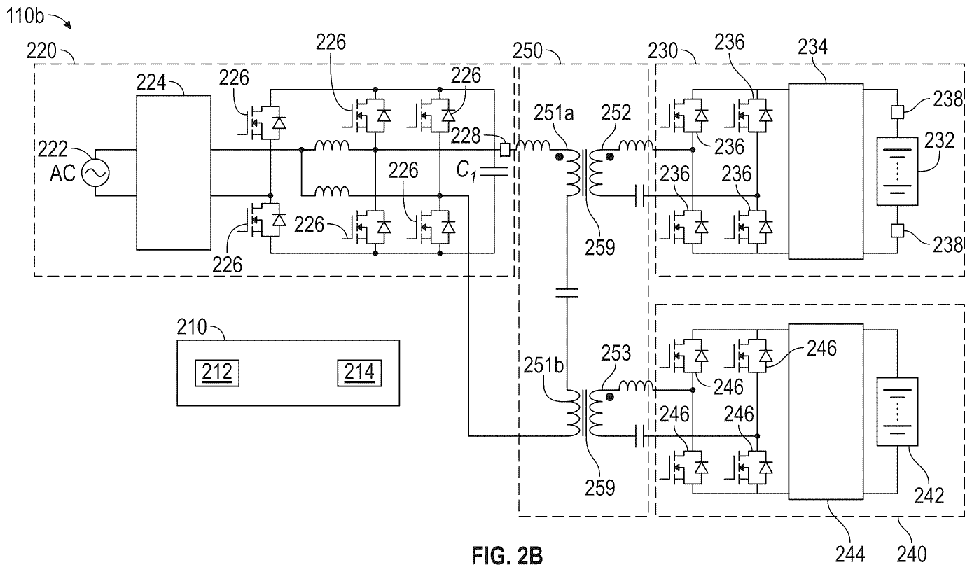

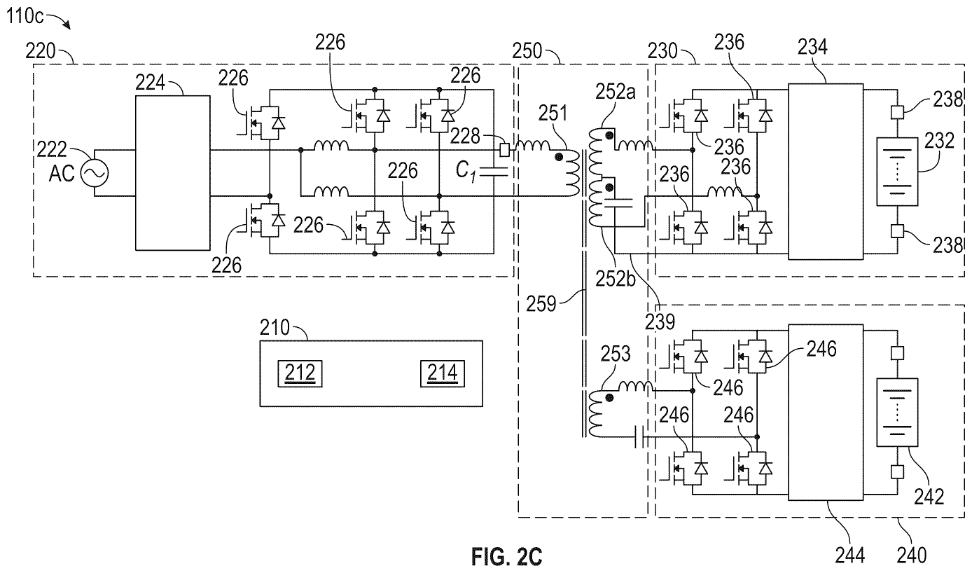

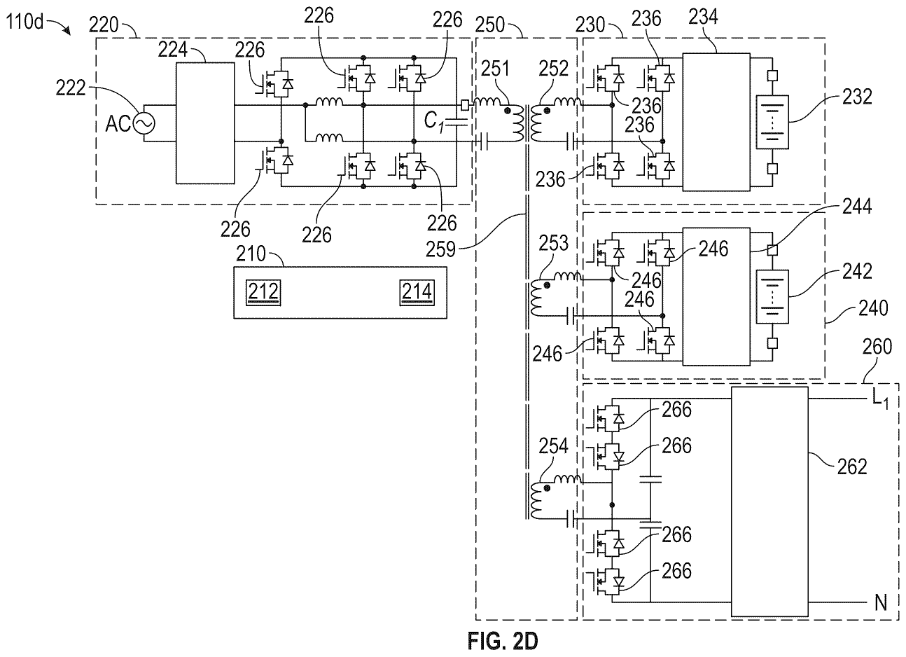

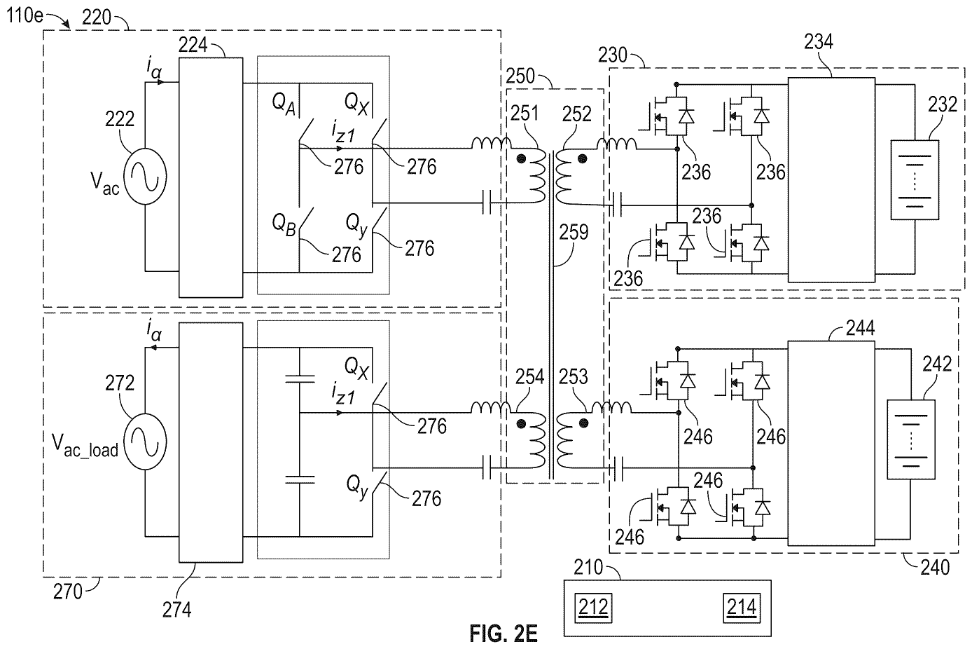

The power converter circuit 110 is used to covert AC electrical power from the external power source 120 (e.g., AC source) into DC electrical power, which is supplied to the battery 102 (e.g., an LV battery and an HV battery). The power converter circuit 110 can include an OBCM, an APM, a V2L DC module, a V 2L AC module and/or the like, including combinations and/or multiples thereof. Various embodiments of the power converter circuit 110 are shown in detail in FIGS. 2A-2E , which are now described.

In particular, FIGS. 2A-2E are block diagrams depicting various embodiments of power converter circuits 110a-110e, which provide single stage bidirectional OBCM and A PM functionality. Each of the power converter circuits 110a-110e are examples of the power converter circuit 110 of FIG. 1.

Each of the power converter circuits 110a-110e includes a controller 210. The controller 210 is responsible for managing power conversion of the power converter circuits 110a-110d within the vehicle 100. The controller 210 includes a processor 212 and a memory 214, which store and execute computer-readable instructions to control the switches (e.g., AC side switches 226, HV switches 236, LV switches 246, among others) of the power converter circuits 110a-110e. The controller 210 communicates with other components (e.g., the battery 102, the ICE 104, the external power source 120, and/or the like, including combinations and/or multiples thereof) to adjust the switches. According to one or more embodiments, the controller 210 can be a microcontroller, digital signal processor (DSP), ASIC, field programmable gate array (FPGA) , and/or the like, including combinations and/or multiples thereof.

The processor 212 within the controller 210 executes the instructions stored in the memory 214 to perform various operations related to power conversion. The processor 212 processes data and signals from other components to determine an operating mode of the vehicle (e.g., driving, charging, etc.). The processor 212 can be one or more devices that can be implemented using various types of hardware, such as microcontrollers, application-specific integrated circuits (ASICs), field-programmable gate arrays (FPGAs), system-on-a-chip (SOC), and/or the like, including combinations and/or multiples thereof.

The memory 214 stores the computer-readable instructions that the processor 212 executes. The memory 214 may also store data related to power conversion, such as voltage and current levels, state of charge (SOC) of the battery 102, and other relevant parameters. The memory 214 enables the controller 210 to perform the functions of the controller 210 effectively by providing the desired instructions and data storage capabilities. The memory 214 can be one or more devices that can implement various types of storage hardware, such as flash memory, random-access memory, read-only memory, and/or the like, including combinations and/or multiples thereof.

Turning now to FIG. 2A, a detailed schematic of a power converter circuit 110a, which is one possible embodiment of the power converter circuit 110 of FIG. 1, is illustrated. The power converter circuit 110a is designed to manage the conversion of electrical power from an AC source to DC for use in various vehicle systems. The power converter circuit 110a includes several interconnected modules and components configured and arranged as shown, each serving a specific function in the power conversion process.

The power converter circuit 110a includes an AC side and a DC side. In the embodiment of FIG. 2A, the AC side includes the AC input 220 and the DC side includes various modules, such as the OBCM section 230 and the APM 240. The AC side and the DC side can include other components, modules, etc., in other embodiments, such as shown in FIGS. 2B-2E. As shown, the AC side and the DC side are separated by a multi-port power transformer 250, which is described in more detail herein.

On the AC side, the AC input 220 begins with an AC source 222, which supplies electrical power to the vehicle 100. This electrical power is first processed through an AC input filter 224, which is responsible for smoothing out any fluctuations or noise in the incoming AC power. The filtered AC power is then directed to a series of AC side switches 226, which are controlled by the controller 210. The AC side switches 226 are used to manage the flow of AC power into the power converter circuit 110a, allowing for precise control over the power conversion process. The AC side switches convert the low frequency (e.g., 47 to 63Hz) AC voltage to high frequency (e.g., 20kHz or higher) modulated AC signal to be applied to a first port (e.g., transfer winding 251) of the multi-port transformer 250. According to one or more embodiments, the AC input 220 includes a relay 228 that can be selectively opened or closed to disconnect the AC input 220 from the DC side. This is useful, for example, when the vehicle 100 is not charging, to prevent any electrical power from entering the AC input 220, such as from the HV battery 232 and/or the LV battery 242.

The DC side of the power converter circuit is divided into two main sections: the OBCM section 230 and the A PM section 240. The OBCM section 230 is connected to an HV battery 232, which may operate at a relatively higher voltage, such as substantially 400-800 Vdc, and the A PM section 240 includes an LV battery 242, which may operate at a relatively lower voltage, such as substantially 12-48 Vdc. According to one or more embodiments, one or more embodiments described herein may be implemented at other AC and/or DC voltage levels.

The OBCM section 230 is connected to a high voltage (HV) battery 232 through an HV output filter 234 and HV switches 236. This module is responsible for charging the HV battery, which powers the vehicle's electric motor and other high-energy systems. According to one or more embodiments, a HV bus of the OBCM section 230 can be pre-charged from either an LV battery 242 or the AC source 222 prior to connecting the HV battery 232 to the OBCM section 230. For example, power can be transferred from the LV battery 242 to the OBCM section 230 to pre-charge the HV bus. Prior to and during pre-charging, relays 238 stay opened to isolate the HV battery 232. When pre-charging is complete, the relays 238 are closed to connect the HV battery 232 to the OBCM section 230.

The APM section 240 is connected to the LV battery 242 via an LV output filter 244 and LV switches 246. The A PM section 240 supplies power to the vehicle's auxiliary systems, such as lighting and infotainment.

According to one or more embodiments, the AC side switches 226, the HV switches 236, and/or the LV switches 246 are integrated in a single modular packaging. According to one or more embodiments, the AC side switches 226, the HV switches 236, and/or the LV switches 246 are connected in parallel with an voltage overshoot absorption circuit. According to one or more embodiments, the AC side switches 226, the HV switches 236, and/or the LV switches 246 are made from Silicon (Si), Silicon Carbide (SiC), Gallium Nitride (GaN), Diamond, Gallium Oxide (Ga₂O₃), Aluminum Nitride (AlN), or other wide band gap (WBG) or ultra-wide band gap (UWBG) semiconductors of suitable voltage and current ratings. According to one or more embodiments, the AC side switches 226, the HV switches 236, and/or the LV switches 246 are one or more of Insulated-Gate Bipolar Transistors (IGBTs), Metal-Oxide-Semiconductor Field-Effect Transistors (MOSFETs), Gallium Nitride High-Electron-Mobility Transistors (GaN HEMTs), or Junction Field-Effect Transistors (JFETs) of lateral, vertical, or cascode structures. According to one or more embodiments, the AC side switches 226, the HV switches 236, and/or the LV switches 246 are monolithic bidirectional switches, which are lateral GaN on Si or later GaN on Saphire with common drain terminal and dual gates. According to one or more embodiments, the AC side switches 226, the HV switches 236, and/or the LV switches 246 are capable of unidirectional and/or bidirectional current flow and voltage blocking capability. According to one or more embodiments, the AC side switches 226, the HV switches 236, and/or the LV switches 246 provide bidirectional power flow between different ports of the power converter circuit 110a. According to one or more embodiments, the AC side switches 226, the HV switches 236, and/or the LV switches 246 are monolithic bidirectional switches with a common source and single gate terminal. According to one or more embodiments, the AC side switches 226, the HV switches 236, and/or the LV switches 246 are monolithic bidirectional switches, which are B-Tran devices. Other switches as described herein may include one or more of these features or functions.

Components on each of the AC side and the DC side are electrically connected to the multi-port power transformer 250, which includes several transformer windings (e.g., transformer windings 251-254 as shown in various of FIGS. 2A-2E) and a magnetic core 259. The transformer windings facilitate the transformation of AC power into AC power at different voltage levels. The magnetic core 259 helps in efficiently transferring energy between the windings, ensuring minimal energy loss during the conversion process. According to one or more embodiments, the transformer windings are connected to provide different voltages on each winding.

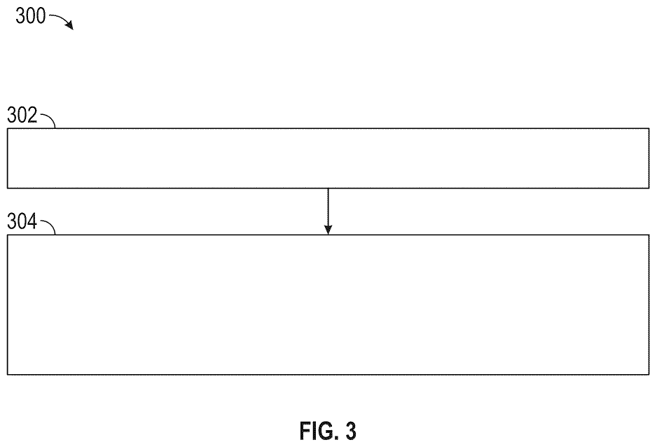

The entire power conversion process is managed by the controller 210, which includes the processor 212 and the memory 214. The controller is tasked with executing the suitable instructions to control the various switches and relays within the circuit, ensuring that power is distributed efficiently and effectively based on the vehicle's current operating mode, which is further described herein with reference to FIG. 3. This control system allows for dynamic adjustment of power flow, optimizing the performance and energy efficiency of the vehicle 100 and its components.

Further embodiments of the power converter circuit 110 are shown in FIGS. 2B-2E as power converter circuits 110b-110e, respectively. These embodiments are now described in more detail, with description of repeated elements/components of FIG. 2A omitted for brevity.

In FIG. 2B, the power converter circuit 110b provides a split AC-side winding of the multi-port power transformer 250. This provides improved coupling and tuning for the A PM section 240. More particularly, the multi-port power transformer 250 includes windings 251a, 251b on the AC side, which correspond respectively to winding 252 for the OBCM section 230 and winding 253 for the A PM section 240.

In FIG. 2C, the power converter circuit 110c provides integrated power decoupling with the OBCM and A PM via circuit path 239

The power converter circuit 110 can provide DC power to a load connected to the vehicle 100 and/or AC power to a load connected to the vehicle, as now described with respect to FIGS. 2D and 2E, respectively.

In FIG. 2D, the power converter circuit 110d provides DC power to a load connected to the vehicle 100 via V2L DC module 260. The V2L DC module 260 is responsible for facilitating the transfer of DC power from the vehicle's power system (e.g., from one of AC source 222, HV battery 232, and/or LV battery 242) to an external DC load. The V2L DC module 260 is useful for enabling the vehicle 100 to supply power to various external devices or systems, enhancing the vehicle's utility and versatility.

The V2L DC module 260 includes a V2L output filter 262, which is used to smooth out the DC power output, ensuring that any fluctuations or noise are minimized before the power is delivered to the external load. The V2L DC module 260 also includes V2L DC switches 266, which are responsible for controlling the flow of DC power from the vehicle's power system to the external load. The V2L DC switches 266 can be operated to either allow or interrupt the power flow, providing precise control over the power delivery process. This capability is useful for managing the power distribution efficiently and safely, ensuring that the external load receives the appropriate amount of power as needed.

In FIG. 2E, the power converter circuit 110e provides AC power to a load connected to the vehicle 100 via V2L AC module 270. AC power is provided from AC source 222 via the multi-port power transformer 250 (using winding 254) to an AC load 272 connected to the V2L AC module 270. In this embodiment, the power converter circuit 110e uses bidirectional blocking switches, which are controllable by the controller 210. Bidirectional blocking switches are semiconductor-based switches capable of preventing current flow in both directions when in the off state while allowing controlled conduction when turned on. For example, the AC input 220 and the V2L AC module 270 include switches 276, which are bidirectional blocking switches. The AC module 270 also includes a filter 274, which is an active or passive filter for smoothing out the AC power output, ensuring that any fluctuations or noise are minimized before the power is delivered to the external load.

Various combinations of the embodiments of FIGS. 2A-2E are possible in other embodiments.

FIG. 3 illustrates a flow diagram of a method 300 for high power density power conversion for vehicles according to one or more embodiments. The method 300 can be implemented by any suitable system or device, such as the controller 210 of FIGS. 2A-2E.

The method 300 begins at operation 302, which involves determining an operating mode of the vehicle 100. The operating modes of the vehicle 100 may include a driving mode, a charging mode, and an idle, each implementing different power management strategies to optimize efficiency and performance. This operation sets the context for the subsequent control actions by assessing the current state or requirements of the vehicle, such as whether it is in a driving, charging, or idle mode.

During the driving mode, the vehicle's power converter circuit (e.g., one or more of the power converter circuits 110a-110e) focuses on supplying power to the electric motor and other vehicle systems, such as infotainment and climate control. The power converter circuit efficiently manages the distribution of power from the HV battery 232 to ensure smooth vehicle operation. In this mode, the power converter circuit may prioritize the conversion of stored DC power from the HV battery 232 to the AC or DC power levels requested by various vehicle components.

In the charging mode, the vehicle 100 is connected to the external power source 120, and the power converter circuit converts AC power from the AC source into DC power to recharge the vehicle's HV battery 232 and/or LV battery 242. The power converter circuit regulates the charging speed, voltage, and current to ensure safe and efficient energy transfer while protecting the batteries from overcharging or overheating. This mode may also involve bidirectional power flow capabilities, allowing the vehicle 100 to supply power back to the grid or other loads if desired.

The idle mode occurs when the vehicle 100 is stationary and not actively charging or driving. In this state, the power converter circuit may focus on maintaining the state of charge of the batteries and powering low-energy systems, such as security and monitoring features. The power converter circuit may also prepare for a transition to another mode by pre-charging certain components (e.g., a HV bus of the OBCM section 230) or adjusting power levels to ensure a seamless switch when the vehicle 100 is ready to drive or charge.

Following the determination of the operating mode, the method 300 proceeds to operation 304. In this operation, the controller 210 controls a first plurality of switches (e.g., the AC side switches 226) and a second plurality of switches (e.g., the HV switches 236 and/or the LV switches 246) based at least in part on the operating mode of the vehicle. These switches are part of the power converter circuit (e.g., one or more of the power converter circuits 110a-110e), which is responsible for managing the flow of electrical power within the vehicle 100. The control of these switches optimizes power conversion and distribution, ensuring that the vehicle's electrical systems operate efficiently and effectively under various conditions.

Additional processes also may be included, and it should be understood that the process depicted in FIG. 3 represents an illustration, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor 112 of FIG. 1) of a computing system (e.g., the controller 210 of FIG. 1), cause the processor to perform the processes described herein.

It should be appreciated that the functioning of any vehicle implementing one or more of the embodiments described herein is improved. M ore particularly, one or more embodiments described herein offer significant benefits and advantages, particularly in enhancing the functionality of vehicles with batteries, including vehicles with HV batteries and LV batteries. For example, one or more embodiments reduces the size and weight of the electrical system of the vehicle by reducing the number and size of components in the power converter circuit. By integrating the OBCM and the APM into a single power converter circuit, one or more embodiments minimizes the need for separate modules, which traditionally occupy more space and add to the vehicle's weight. This integration is achieved through the use of a multi-port power converter, which efficiently manages the conversion of AC power from the AC source to DC power for the vehicle's HV and LV batteries.

Another significant improvement is the increase in energy efficiency. The power converter circuit described herein utilizes a single-stage conversion process, which reduces the number of conversion stages typically implemented in traditional systems. This reduction in conversion stages minimizes energy losses, thereby enhancing the overall efficiency of the vehicle's electrical system. The use of multi-port planar magnetics, including transformer windings and a magnetic core, further contributes to this efficiency by ensuring effective energy transfer with minimal losses.

The vehicle also benefits from improved power management capabilities. The controller described herein dynamically adjusts the operation of the power converter circuit based on the vehicle's current operating mode. This adaptability allows the vehicle to optimize power distribution for different scenarios, such as driving, charging, or idling, ensuring that the vehicle's electrical systems receive the appropriate power levels for efficient operation. Additionally, the system's ability to handle bidirectional power flow enables advanced functionalities like vehicle-to-grid, vehicle-to-vehicle, and vehicle-to-load operations, further enhancing the vehicle's versatility and energy management capabilities.

Overall, the improvements brought by the high power density power conversion system enhance the vehicle's performance, efficiency, and functionality, making it better suited to meet the demands of modern electric and hybrid vehicles.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A power converter circuit for a vehicle, the power converter circuit comprising:
a multi-port power converter to convert alternating current (AC) electrical power from an AC side of the power converter circuit to a direct current (DC) side of the power converter circuit, wherein the AC side of the power converter circuit is electrically connected to an AC source, wherein the multi-port power converter comprises a plurality of planar magnetics;
an onboard charging module electrically connected to the DC side of the power converter circuit and to a high voltage (HV) battery;
an accessory power module electrically connected to the DC side of the power converter circuit and to a low voltage (LV) battery; and
a controller to control a first plurality of switches associated with the AC side of the power converter circuit and a second plurality of switches associated with the DC side of the power converter circuit, wherein the controller controls the first plurality of switches and the second plurality of switches based on an operating mode of the vehicle.

2. The power converter circuit of claim 1, wherein the multi-port power converter is an indirect AC/DC converter.

3. The power converter circuit of claim 1, wherein the multi-port power converter is a direct AC/DC converter.

4. The power converter circuit of claim 1, wherein the first plurality of switches and the second plurality of switches are integrated into a single modular package.

5. (canceled)

6. The power converter circuit of claim 1, wherein the multi-port power converter comprises a plurality of transformer windings, where the plurality of transformer windings are connected to accept or provide different voltages on each winding.

7. The power converter circuit of claim 1, wherein a high voltage bus of the onboard charging module is pre-charged using the LV battery or the AC source prior to connecting the HV battery to the onboard charging module.

8. The power converter circuit of claim 1, wherein the multi-port power converter comprises a split winding.

9. The power converter circuit of claim 1, wherein the onboard charging module includes integrated power decoupling.

10. The power converter circuit of claim 1, further comprising a DC vehicle-to-load module electrically connected to the DC side of the power converter circuit and to a low voltage DC load.

11. The power converter circuit of claim 1, further comprising an AC vehicle-to-load module electrically connected to the AC side of the multi-port power converter and to an AC load.

12. A vehicle comprising:
a high voltage battery to provide electrical power to an electric motor of the vehicle;
a low voltage battery to provide electrical power to an electrical system of the vehicle;
a multi-port power converter to convert alternating current (AC) electrical power from an AC side of the vehicle to direct current (DC) electrical power on a DC side of the vehicle, wherein the AC side of the vehicle is electrically connected to an AC source;
an onboard charging module electrically connected to the DC side of the vehicle and to a high voltage (HV) battery;
an accessory power module electrically connected to the DC side of the vehicle and to a low voltage (LV) battery; and
a controller to control a first plurality of switches associated with the AC side of the vehicle and a second plurality of switches associated with the DC side of the vehicle, wherein the controller determines the operating mode of the vehicle, wherein the operating mode is selected from a group comprising a driving mode, a charging mode, and an idle mode, and wherein the controller dynamically adjusts a power flow through the multi-port power converter by controlling the first plurality of switches and the second plurality of switches based on the operating mode of the vehicle.

13. The vehicle of claim 12, wherein the multi-port power converter comprises a plurality of transformer windings, where the plurality of transformer windings are connected to provide different voltages on each winding.

14. The vehicle of claim 12, wherein a high voltage bus of the onboard charging module is pre-charged using the LV battery or the AC source prior to connecting the HV battery to the onboard charging module.

15. The vehicle of claim 12, wherein the multi-port power converter comprises a split winding.

16. The vehicle of claim 12, wherein the onboard charging module includes integrated power decoupling.

17. The vehicle of claim 12, further comprising a DC vehicle-to-load module electrically connected to the DC side of the vehicle and to a DC load.

18. The vehicle of claim 12, further comprising an AC vehicle-to-load module electrically connected to the AC side of the vehicle and to an AC load.

19. A method comprising:
determining an operating mode of a vehicle; and
controlling a first plurality of switches and a second plurality of switches based at least in part on the operating mode of the vehicle, wherein the first plurality of switches and the second plurality of switches are disposed in a power converter circuit,
wherein the power converter circuit comprises:
a multi-port power converter to convert alternating current (AC) electrical power from an AC side of the power converter circuit to a direct current (DC) side of the power converter circuit, wherein the AC side of the power converter circuit is electrically connected to an AC source, wherein the multi-port power converter comprises a plurality of planar magnetics;
an onboard charging module electrically connected to the DC side of the power converter circuit and to a high voltage (HV) battery;
an accessory power module electrically connected to the DC side of the power converter circuit and to a low voltage (LV) battery; and
a controller to control the first plurality of switches, which are associated with the AC side of the power converter circuit, and the second plurality of switches, which are associated with the DC side of the power converter circuit,
wherein controlling the first plurality of switches comprises converting low frequency AC voltage to a high frequency modulated AC signal.

20. The method of claim 19, wherein the multi-port power converter comprises a plurality of transformer windings, where the plurality of transformer windings are connected to provide different voltages on each winding.

21. The method of claim 19, wherein the low frequency AC voltage is substantially 47 Hz to substantially 63 Hz, and wherein the high frequency AC modulated AC signal is substantially 20 kHz or greater.
